(19) United States
(12) Patent Application Publication
(10) Pub. No.: US 2012/0182285 A1
(43) Pub. Date: Jul. 19, 2012

(54) SYSTEM FOR THE VISUALIZATION OF STATUS INFORMATION OF FIELD DEVICES

(75) Inventors: Fridolin FAIST, Oberwolfach (DE); Martin WETTLIN, Schiltach (DE)

(73) Assignee: VEGA Grieshaber, KG

(21) Appl. No.: 13/350,028

(22) Filed: Jan. 13, 2012

(30) Foreign Application Priority Data
Jan. 19, 2011 (DE) DE 102011008941

(51) Int. Cl. G06T 1/00

(52) U.S. Cl. 345/418

(57) ABSTRACT

The invention concerns a system for the visualization of status information of at least one field device, which communicates by a bus system with an operating unit by means of a PC-based operating tool; according to the invention, it is provided that the PC-based operating tool has an interface for the data exchange with a mini-application embedded in a graphic user interface of the operating unit, and the status information is displayed by means of the mini-application.

### CROSS REFERENCES TO OTHER APPLICATIONS

The present application claims the priority of the German Patent Application No. DE 102011008941, filed on Jan. 19, 2011; the entirety of which is hereby incorporated by references.

### BACKGROUND OF THE INVENTION

1. Field of the Invention

The present application relates to visualization of the status information of at least one field device. More particularly, this application relates to a mini-application system that constantly monitors and displays the status information of a field device which communicates by a bus system with a host operating unit by means of a personal computer (PC) based operating tool.

2. Description of the Related Art

For the diagnosis, parameterization or visualization of field devices connected by means of a bus system one typically uses systems in the form of PC-based programs (engineering tools). These systems communicate via a predetermined, most often standardized communication technology (Ethernet, PROFIBUS, HART, etc.) with the particular field device and provide a visualization on an operating unit with display that is usually connected directly to the bus system or a control computer of the field device. A visualization represents, for example, parameters read out from the field device in graphic, tabulated or numerical fashion on the display and can provide input masks for entering the corresponding device parameters and transmitting them to the particular field device for parameterization.

In order to operate a plurality of field devices from a central station, an operating software is available as an operating tool, making possible access to the different field devices under a common user interface. These operating tools provide functions for representation of the actual bus topology; moreover, they provide additional user interfaces for setting up and monitoring the individual field devices and user interfaces for bus configuration. These operating tools provide an architecture, a framework or frame that affords, for example, a uniform appearance of messages and operating elements of field devices.

Examples of operating tools are products such as PACTware™, Fieldcare or Fieldmate, which are based on the FDT/DTM (field device tool/device type manager) technology, technology. FDT (Field Device Tool) standardizes the communication and configuration interface between all field devices and host systems. FDT provides a common environment for accessing the devices' most sophisticated features. Any device can be configured, operated, and maintained through the standardized user interface—regardless of supplier, type or communication protocol. The DTM provides a unified structure for accessing device parameters, configuring and operating the devices, and diagnosing problems. DTMs (Device Type Manager) can range from a simple Graphical User Interface for setting device parameters to a highly sophisticated application capable of performing complex real-time calculations for diagnosis and maintenance purposes.

The FDT/DTM technology provides a series of defined interfaces by which a FDT frame application (such as PACTware™) can communicate with the integrated DTMs as driver software of the device manufacturer. These interfaces all the device manufacturers to make free use of all Windows operating elements to configure the user interface of the particular field device.

Another technology makes use of the Electronic Device Description (EDD) concept or the Enhanced EDD (EEDD) concept. A special description language exists for the description of the user interface, the so-called Device Description Language (DDL), on which is based, e.g., the product SIMATIC PDM of Siemens. Only elements that are available in this description language can be used to configure the user interface. DDL constitutes a foundation technology that is used by suppliers of host systems to develop stable man-machine and automation interfaces. Field devices based on DDL are connected in identical manner to the different host systems regardless of the manufacturer. If changes are needed in the host operating system (DD-host), the descriptions of the field devices (FDD) remain unaffected by this.

What is common to both technologies is that they are not yet usable in themselves. They only become usable when the corresponding device drivers for the field devices being operated have been loaded. This is the DTM (device type manager) in the case of the FDT technology and the FDD (field device description) in the case of the DD-hosts.

In order to integrate a field device in an operating tool, a description of the user interface of the particular field device is needed. Such a description of the user interface is individually composed for each field device. In this description, device parameters, i.e., the device description, are described in a description language so that the parameters can be interpreted by the operating tool. Thus, in order for the user interface to in fact communicate with a field device, the actually used topology of the realworld device must first be simulated within the user interface.

### ASPECTS AND SUMMARY OF THE INVENTION

The present application creates a simple user interface and program that provides a constant visualization of the status information of field devices which communicate via a bus system with an operating unit by means of a PC-based host operating tool, using a compressed and comprehensive symbol system of NE 107. An operator can instantly recognize whether the equipment being monitored is operating in the permissible range or whether parts of the installation are in need of maintenance, without this operator having to call up and start any host operating tools or gather information in complex and complicated user interfaces.

In one embodiment, as summarized a mini-application embedded in a graphic user interface of the host operating unit, which automatically and repeatedly performs the steps of 100, 60, 65, 66, 67 and 101 of FIG. 8, the status information is displayed in a mini-application user interface and displayed on a mini-display 30-1.

In one embodiment, the mini-application is a gadget or an applet, preferably a Windows™ mini-application, the user can identify on his operating unit the equipment status of the field devices connected to a field bus, without having to check the states of the individual field devices in a complex user interface. Moreover, such mini-applications can be focused on a given task and be shown always in the foreground of a user interface, for example on Windows™ desktop. Steps of 100, 60, 65, 66, 67, and 101 of FIG. 8 are automatically performed constantly. By a mini-application, also known as a widget or applet, is meant a small computer program that is incorporated into a graphic user interface or web page. As a rule, such mini-applications involve auxiliary or service programs or tools (clock, weather, or also a search box function).

Such mini-applications are known for host PCs with Windows™ operating system “Microsoft Windows Vista” or “Microsoft Windows 7” and they enable a compact representation of important data that is represented on the Windows™ desktop in a region provided for this.

One advantageous embodiment of the invention provides, for the architecture of the PC-based operating tool, the FDT/DTM (field device tool/device type manager) technology or the EDD/DDL (electronic device description/device description language) or EEDD/DDL (enhanced electronic device description/device description language) concept, preferably the status information provided is the status information corresponding to the NAMUR recommendation NE107. This enables an especially compendious presentation of all field devices, since the operator is only presented with one of the five pieces of status information of NE107 as the diagnostic information for all field devices being monitored.

It is therefore possible to provide several field devices with device-specific PC-based operating tools that are based on different architectures, whose operating state is displayed with the mini-application of the invention in a single and compendious representation.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic representation of a topology of a field bus with two field devices to explain the system of the invention.

FIG. 2 is a schematic representation of a bus/device structure per FIG. 1, simulated on a user interface.

FIG. 3 is a schematic representation of the user interface per FIG. 2 with a selected object.

FIG. 4 is a schematic representation of the bus/device structure per FIG. 1, simulated on a user interface, with a representation of diagnostic information per the NAMUR recommendation 107.

FIG. 5 is a schematic representation of the software components of the system according to the invention as a sample embodiment.

FIG. 6 is a schematic representation of the status information of three field devices in a mini-application according to the system of the invention per FIG. 3.

FIG. 7 is another schematic representation of the status information of a selected field device in a mini-application according to the system of the invention per FIG. 5.

FIG. 8 illustrates a summary of the operating process described.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. For purposes of convenience and clarity only, directional (up/down, etc.) or motional (forward/back, etc.) terms may be used with respect to the drawings. These and similar directional terms should not be construed to limit the scope of the invention in any manner.

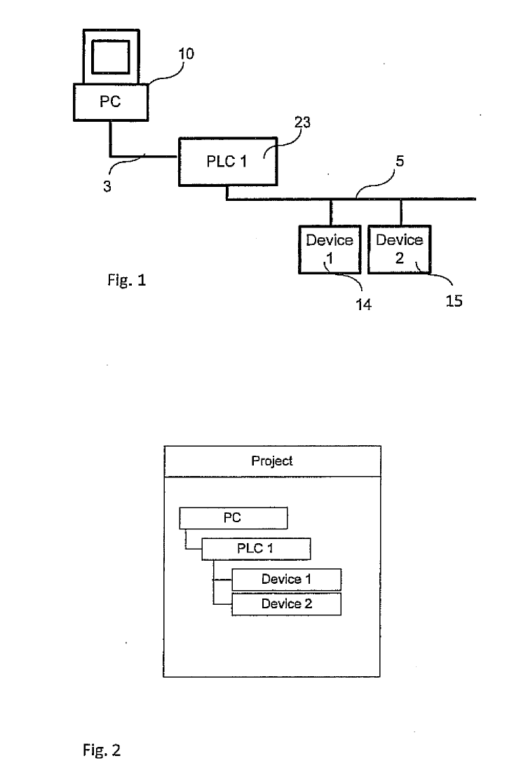

Referring now to FIGS. 1 to 4.

One example of a realworld topology is shown in FIG. 1. In this example, a personal computer (PC) 10 as the operating unit is connected via a serial interface 3 to a controller 23. The controller 23 has a field bus 5, on which the field devices 14 and 15 are connected. An operating tool as described above is installed on the operating unit 10, which creates a corresponding user interface.

FIG. 2 shows, as an example, how this topology per FIG. 1 needs to be simulated in one of the aforementioned user interfaces. This graphic representation of the bus/device structure per FIG. 1 is implemented as a tree diagram. For each subscriber, the suitable information must be properly entered in the user interface, such as the device type setting, the bus type used (e.g., Profibus, Foundation Fieldbus, etc.), the bus address settings, etc., in order for the device drivers to also communicate with the realworld devices. The simulated bus/device structure in this scenario is usually termed a project and it is saved in memory, accordingly, as a project file.

The simulating of such a topology in an operating tool or operating program requires some technical knowledge as to the field devices used and must be performed correctly in all points in the user interface. This has proven to be highly fraught with error in the case of operating tools that only support manual simulation of the topology. For this reason, some operating tools are already offering solutions with automated project layout. Prompted by the program startup of the operating tool or by the user activating a particular function in the operating tool, this automatically executes a function that provides an automated project layout for the particular bus topology by specific querying of the connected bus system. Project files generated in this way already contain the information as to device types, their bus addresses and the bus structures. Such solutions are available especially in the case of the operating tool PACTware™ and they can even simulate complex bus structures through several hierarchical levels.

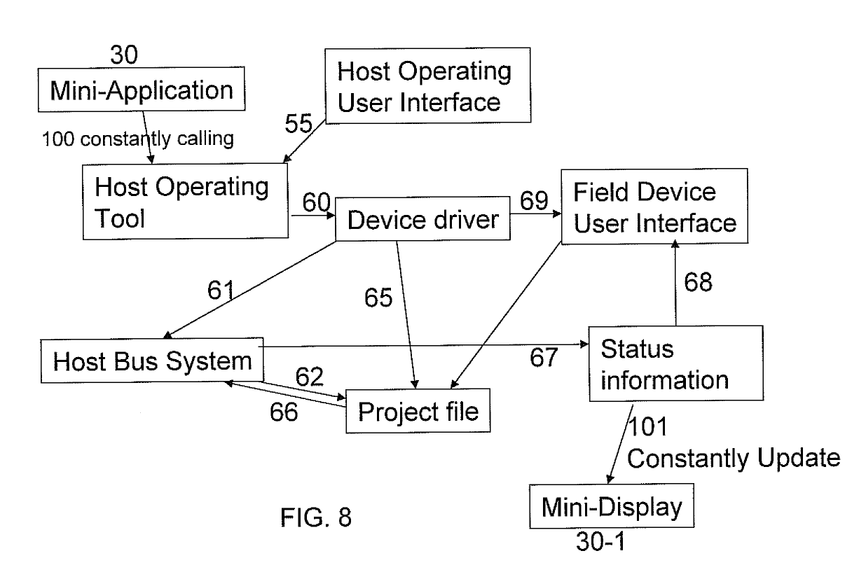

The generation of a project file is summarized in FIG. 8 steps 55, 60, 61 and 62.

As has already been made clear, each object of the project file represents a field device of the realworld topology. Thus, the calling up of the particular device driver occurs directly by selection in the project file. FIG. 3 depicts how the selecting of object “Device 1” opens the user interface of the corresponding device driver “Device 1” as a second window, in which parameters 1 and 2, functions “Function 1” and “Function 2”, and a state “State 1” can be called up. In this way, the user can check all settings of the field device “Device 1” in this user interface (Function 1, Function 2), or change them (Parameter 1, Parameter 2). He can also query information on the current device status (State 1) in this user interface. Thus, it would be possible by individual opening of all device driver user interfaces to gain a survey of the current status of the installation. In small installations, such a procedure is possible to continually check the status of the installation. But in the case of larger installations with several hundred field devices, for example, this procedure is not practicable.

This process of host operating tool and user interface in checking and displaying the status information of a field device is summarized in FIG. 8 steps 55, 60, 65, 66, 67, and 68 and results in displaying via a mini-display 30-1.

For this reason, the FDT interface was expanded with a method for improved diagnosis. This enables, for the FDT framework application, the use of the DTM entities of the project file for active querying of the diagnostic information of the individual DTMs without the need for specific opening of the DTM user interface. This method provides the diagnostic information already in the form of a so-called “compressed” display per NE 107 (NAMUR recommendation 107). NE 107 already takes account of the fact that the user only receives the most important information for him. Accordingly, the long lists of different error codes have been categorized in this recommendation and thereby reduced to 4 fundamental error states. The method mentioned here provides only the five pieces of information (“OK” and 4 error states) from NE 107 to the framework application. The four error states represent the following categories per the following table:

| Error state | Symbols per NE 107 |
|---|---|
| function check OK | [symbol] |
| off specification | [symbol] |
| needs maintenance | [symbol] |
| failure | [symbol] |

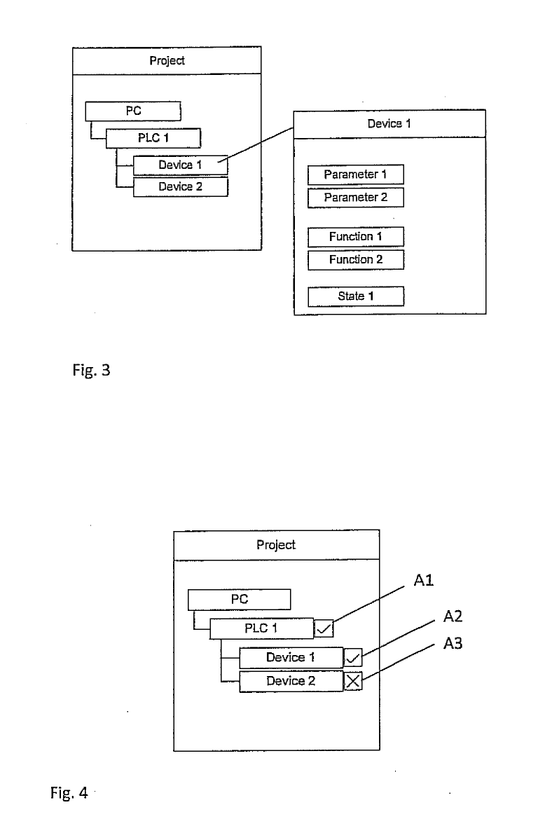

FIG. 4 shows how this new method can be used within the project view of a FDT framework application. The graphic representation of the bus/device structure corresponds to that of FIG. 2, but has additional display fields A1, A2 and A3 for the controller PLC 1, the field device “Device 1” and the field device “Device 2”. These display fields A1 to A3 can be occupied by one of the four symbols of NE 107 according to the table above. In this way, the user can quickly see which devices in the overall installation need to be checked. In FIG. 4, a check mark is shown for the OK status of field device “Device 1” and the controller PLC 1, and the corresponding symbol from the above table for the “Failure” status of field device “Device 2”.

This function can be used if the DTMs are outfitted with the required interface and the user interface executes this function and shows the results. Since the method has been adopted in the FDT standard, future products will also be able to support this method.

Thus, through corresponding extra functions with user interfaces in the FDT framework application, the prerequisite also exists to basically assemble the individual pieces of status information in an overall system status and display this in the FDT framework application. Querying of the individual pieces of status information can be automated and done here in cycles, i.e., FIG. 8 steps 55, 60, 65, 66, 67, and 68 can be automatically repeated with a program.

However, the drawback to such a solution is that the user is moving within a user interface that is primarily designed to set up and operate individual devices within an overall installation and, accordingly, is basically oriented to this. In any case, this requires a large number of operating elements, which typically leads to overly complicated user interfaces for inexperienced users.

Moreover, operating tools are known that additionally provide user interfaces for the programming of the actual control functions. In highly integrated solutions, user interfaces are offered specially for the programming of visualization windows for process variables in graphically elaborate representations. One provider of such operating tools is the engineering system “System 800xA” from ABB. Although the visualization windows offer every conceivable display variant to the user, they must be individually reprogrammed. For the programming of such solutions, the equipment operators must often call upon specialized engineering offices, which entails high costs. In event of changes or additions to the system, again appropriate adaptations must be done with further high costs.

In order to integrate a field device in an operating tool, a description of the user interface of the respective field device is necessary. The user interface is created individually for each field device. In the user interface, device parameters, i.e., the device description, are described in a description language, so that the parameters can be interpreted by the operating tool. Since the description language is standardized for the particular operating tool architecture, it is possible to bring together the operating of field devices of different manufacturers under a common and simplified user interface or tool.

The problem of the present invention is to create a system for the visualization of status information of field devices which communicate via a bus system with an operating unit by means of a PC-based operating tool, enabling a compressed and comprehensive monitoring of the field devices so that an operator can instantly recognize whether the equipment being monitored is operating in the permissible range or whether parts of the installation are in need of maintenance, without this operator having to call up and start any operating tools or gather information in complex and complicated user interfaces.

Such a system for the visualization of status information from at least one field device, which communicates via a bus system with an operating unit by means of a PC-based operating tool, is characterized according to the invention in that the PC-based operating tool has an interface for the data exchange with a mini-application (gadget, applet) embedded in a graphic user interface of the operating unit, and the status information is displayed by means of the mini-application.

With such a mini-application (gadget, applet), preferably a Windows™ mini-application, the user can identify on his operating unit the equipment status of the field devices connected to a field bus, without having to check the states of the individual field devices in a complex user interface. Moreover, such mini-applications can be focused on a given task and be shown always in the foreground of a user interface.

By a mini-application, also known as a widget or applet, is meant a small computer program that is incorporated into a graphic user interface or web page. As a rule, such mini-applications involve auxiliary or service programs or tools (clock, weather, or also a search box function). These mini-applications require an environment that provides basic functions and resources via a programming interface and thus cannot be used as self-standing, independent programs on an operating system.

Such mini-applications are known for host PCs with Windows™ operating system “Microsoft Windows Vista” or “Microsoft Windows 7” and they enable a compact representation of important data that is represented on the Windows™ desktop in a region provided for this.

One advantageous embodiment of the invention provides, for the architecture of the PC-based operating tool, the FDT/DTM (field device tool/device type manager) technology or the EDD/DDL (electronic device description/device description language) or EEDD/DDL (enhanced electronic device description/device description language) concept, preferably the status information provided is the status information corresponding to the NAMUR recommendation NE107. This enables an especially compendious presentation of all field devices, since the operator is only presented with one of the five pieces of status information of NE107 as the diagnostic information for all field devices being monitored.

It is therefore possible to provide several field devices with device-specific PC-based operating tools that are based on different architectures, whose operating state is displayed with the mini-application of the invention in a single and compendious representation

To explain the first sample embodiment according to FIG. 5, we make reference to a field bus structure per FIG. 1, but instead of two field devices 14, namely, Device 1 and Device 2, it has three field devices 14, designated hereinafter as Device 1, Device 2, and Device 3.

On the operating unit 10, a personal computer PC with monitor screen, there is installed an operating tool for the field devices: Device 1, Device 2 and Device 3. This operating tool can be based, e.g., on the FDT/DTM technology or on the EDD concept. This situation is shown in FIG. 5, a schematic representation of the operating unit 10 (including monitor screen) with a software structure according to the sample embodiment. This software structure consists of the operating tool 20, which has an interface 50 to a mini-application 30, which is embedded in a graphic user interface 40. This interface 50 serves to relay certain status information of the field devices to the mini-application for display. If this operating unit 10, configured as a PC, has a Windows™ operating system, the corresponding Windows™ mini-applications are available that are embedded in the Windows™ user interface.

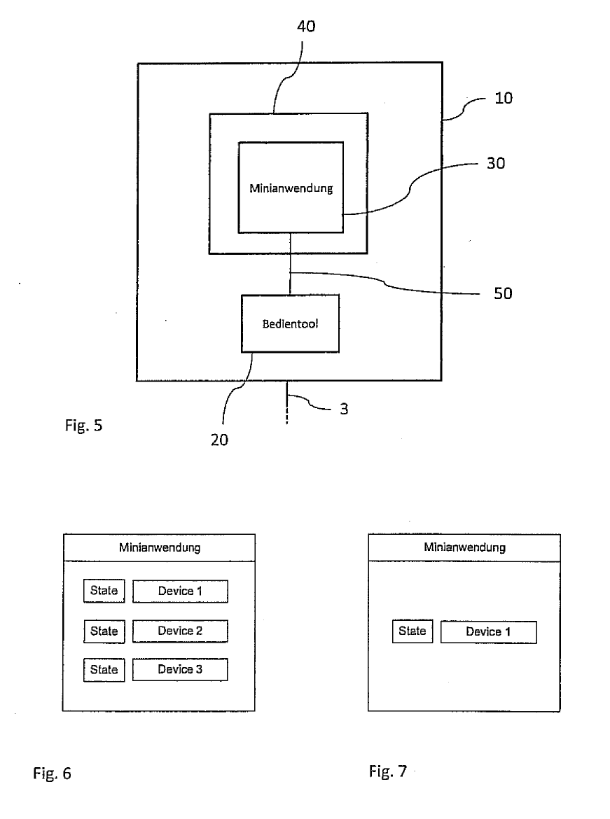

At the three field devices connected to the field bus 5 (FIG. 1): Device 1, Device 2, and Device 3, the graphic representation of the mini-application in FIG. 6 is shown in the form of a table with three lines and one column. In the first column are entered the status conditions “State” and in the second column the designations of the field devices “Device 1”, “Device 2” and “Device 3”. The status condition is one of the five pieces of information proposed according to NE107, i.e., the status “in order” or “OK” and the four error states: function check, off specification, needs maintenance and failure. To characterize the status condition, either a “check mark” as the graphic symbol for the “OK” condition or one of the graphic symbols for the four error conditions per NE 107 is set. This status information is cyclically queried by the operating tool and graphically presented via the interface 50 by means of the mini-application 30.

Such a mini-application is displayed on the desktop of the operating unit 10 constantly in the foreground in a freely selectable location. Since the operating tool cyclically queries the operating states and the status information of the field devices, the current status information is constantly available to the operator in a compendious representation.

Such mini-applications can be easily configured to adapt the information content of the display to given requirements. Thus, per FIG. 7, a display of a mini-application can be confined solely to representing the status information of a particular field device “Device 1”. This graphic representation therefore consists solely of one line with two columns, which enter the condition “State” and the designation of the field device being monitored, “Device 1”. The symbols of recommendation NE 107 as described in the mini-application per FIG. 6 serve as the status condition.

Instead of the PC 10, the controller 23 (FIG. 1) can also serve as the operating unit, and then the operating tool 20 with the interface 50 and the mini-applications 30 can be installed and operated on it.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A method for constantly monitoring and visualizing a running status information of a field device in a PC-based host operating user interface and a host operating tool, comprising the steps of:
generating a mini user interface that constantly runs within the host-operating user interface;
generating a mini-application that repeatedly calls the host operating tool to obtain the running status information of said field device; and
displaying said running status information on said mini user interface.

2. The method of claim 1, wherein said mini user interface is an applet or a gadget that runs within a Windows™ user interface.

3. The method of claim 1, wherein said host operating tool implements FDT/DTM functionalities, and said mini-application interacts with said FDT/DTM functionality.

4. The method of claim 1, wherein said running status information is compressed in accordance to the NAMUR Recommendation NE 107.

5. The method of claim 1, further comprising the step of automatically updating said running status information at a specific time.

6. The method of claim 1, wherein said mini user interface is focused in one specific type of running status information and constantly runs on the foreground of said host user interface.

7. A device running a mini-application program for constantly monitoring and visualizing a running status information of a field device electronically connected with a PC-based host operating user interface and a host operating tool, comprising:
a display showing a mini user interface that constantly runs within the host-operating user interface; and
an operating hardware that operates the mini-application program that repeatedly calls the host operating tool to obtain the running status information of said field device; and
wherein said running status information is automatically displayed on said mini user interface.

8. The device of claim 7, wherein said mini user interface is an applet or a gadget that runs within a Windows™ user interface.

9. The device of claim 7, wherein said host operating tool implements FDT/DTM functionalities, and said mini-application interacts with said FDT/DTM functionality.

10. The device of claim 7, wherein said running status information is compressed in accordance to the NAMUR Recommendation NE 107.

11. The device of claim 7, wherein said mini user interface is automatically updated with said running status information at a specific time.

12. The device of claim 7, wherein said mini user interface is focused in one specific type of running status information and constantly runs on the foreground
of said host user interface.
